(19) United States
(12) Patent Application Publication
(10) Pub. No.: US 2006/0290132 A1
(43) Pub. Date: Dec. 28, 2006

(54) Greeting cards

(76) Inventor: Laaong Silaprom, Ponders End Enfield (GB)

Correspondence Address: Laaong Silaprom, 403 West 46th Street, New York, NY, 10036, US

(21) Appl. No.: 10/555,615

(22) PCT Filed: May 20, 2003
(86) PCT No.: PCT/GB03/02177

§ 371 Date: May 9, 2006

(30) Foreign Application Priority Data
May 20, 2002 (GB) 0211541.8

(51) Int. Cl. B42D 19/00

(52) U.S. Cl. 281/5

(57) ABSTRACT

A greeting card (1) is provided with a detachable reply post card (3).

This invention relates to a greetings card that has three pages.

It is of course well known for other kinds of greetings cards to have three pages but in the case of the present invention the third page is not a decorative one.

In the case of the present invention, the third page of the greetings card is a reply post card.

The reply post card would be detachable. when detached it would leave the greetings card as a normal two page greetings card.

The detachable reply postcard would be in the form of the third page of the greetings card that is removable along suitable lines of weakness, for example perforations. However alternative means of detachment may be employed. It could also have no lines of weakness and in this case it would simply be cut off with scissors along a printed dotted line.

Below is a description of the invention with reference to the accompanying drawings in which:

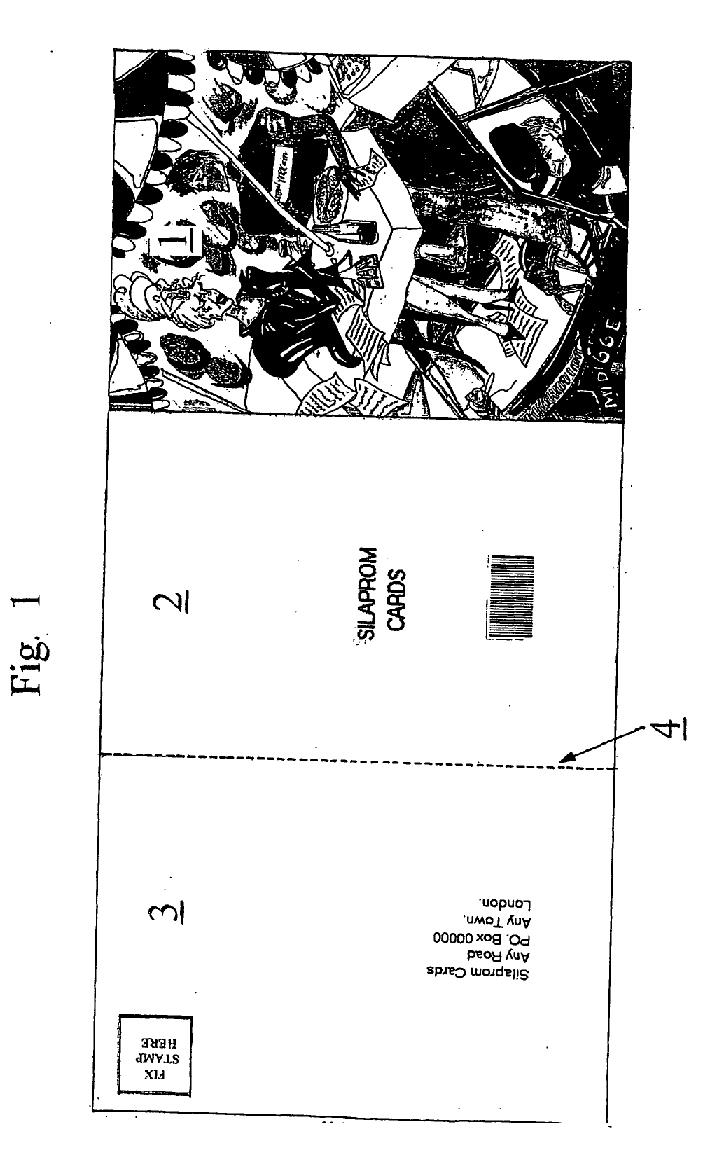

FIG. 1 is a view of the outside of the greetings card.

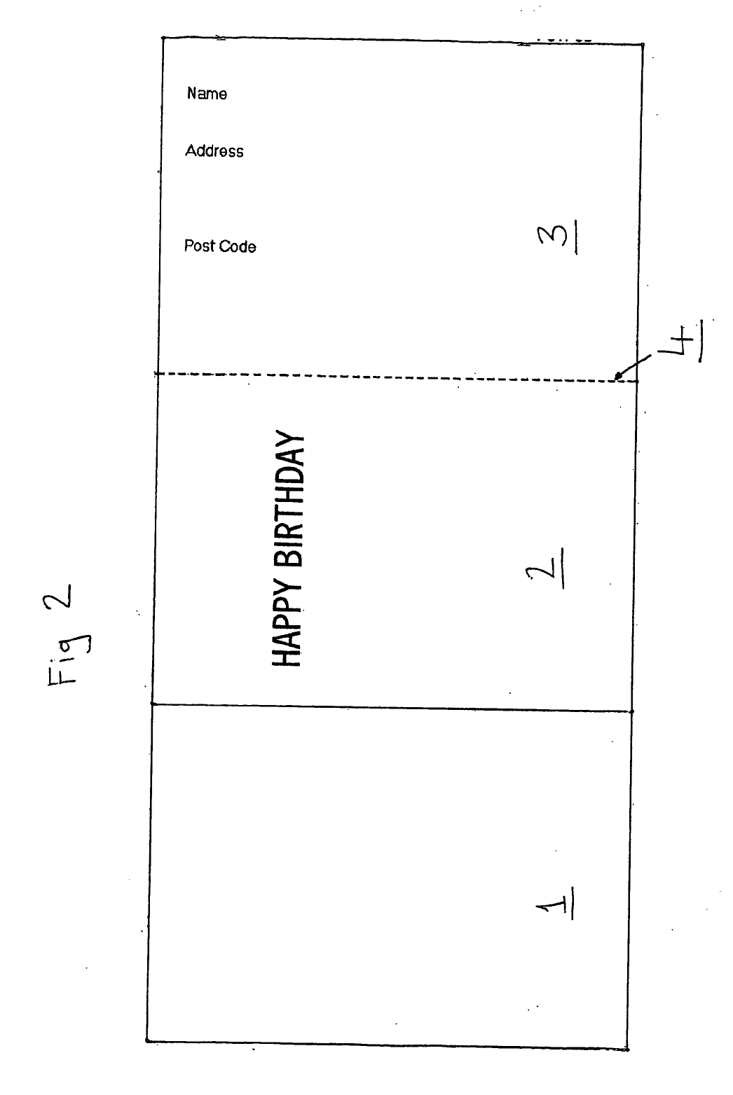

FIG. 2 is a view of the inside of the greetings card.

In the figures similar features have been given the same reference numerals for ease of identification.

Referring first to FIG. 1 there are the three pages of the greetings card 1,2 & 3.

Surface 1 is the outside of the front page of the greetings card, the usual decorative page.

Surface 2 is the outside of the back page of the greetings card, the page that usually has the information on e.g. Price code, card company name, artist name.

Surface 3 is the outside of the detachable reply post card. In this instance with the card publishers details and a box to place a stamp in.

The card would be displayed as any normal two page greetings card would be. Page 3 would be folded over onto page 2 and then page 1 would be folded on top of page 3. When folded the greetings card would appear as any normal two page greetings card.

The dotted line 4 is a perforated line or alternatively it is simply a printed dotted line to be cut along with scissors.

Since the reply post card 3 is detachable, the bulk of the greeting card would be retained for sentimental reasons.

The invention thus provides a greetings card with a reply post card for the recipient to send his or her details back to the card company or any other organisation that published such a greetings card.

The information received by the greetings card publishers could be used for any number of promotions

Referring now to FIG. 2. Surface 1 is the inside of the front page of the greetings card. Surface 2 is the inside of the back page of the greetings card. Surface 2 comes with a greeting, in this instance “Happy Birthday”. Surface 2 also comes with enough unused space for the sender to write a personal message.

Surface 3 is the detachable reply post card with spaces for the recipient to fill in his or her details. These details could then be used for any number of company promotions.

1) A greetings card incorporating a reply post card for use by the intended recipient of the greetings card.

2) A greetings card according to claim 1 in which the reply post card is integral with the card.

3) A greetings card according to any one of the preceding claims in which the reply post card is detachable from the greetings card.

4) A greetings card according to claim 3 in which the detachable reply post card is in the form of a section of the card that is removable along suitable lines of weakness or alternatively the reply post card could be cut out with scissors along a printed dotted line.

5) The reply post card is integral with the greetings card and would be detachable for use by the recipient of the greetings card.

6) A greetings card according to any one of the preceding claims in which the greetings card carries an appropriate greeting dependent upon the occasion to be celebrated and the card is presented with artwork of an aesthetic character on its outer surface or surfaces to confer the usual decorative and attractive appearance

7) A greetings card substantially as herein before described with reference to FIG. 1, 2, of the accompanying drawings.
